(19) United States
(12) Patent Application Publication
(10) Pub. No.: US 2005/0011114 A1
(43) Pub. Date: Jan. 20, 2005

(54) Outdoor protective cover

(76) Inventor: Annette E. Craven, Brighton, MI (US)

Correspondence Address: FOSTER, SWIFT, COLLINS & SMITH, P.C., 313 SOUTH WASHINGTON SQUARE, LANSING, MI, 48933, US

(21) Appl. No.: 10/427,153

(22) Filed: Apr. 30, 2003

(51) Int. Cl. A01G 13/02

(52) U.S. Cl. 47/29.2

(57) ABSTRACT

An outdoor protective cover for protecting outdoor plants and other objects from adverse weather conditions including an upper cover configured to provide an interior space. The upper cover includes an outer surface having any of a variety of decorative displays, a top portion and an open bottom portion. The decorative display may include features molded integrally with the upper cover, painted on features, or preprinted graphical or pictorial illustrations affixed to the upper cover. The decorative display may further include lights, reflective components, or fiber optics attached to the upper cover to provide additional decorative characteristics.

### BACKGROUND OF THE INVENTION

1. Field of the Invention

The present invention generally relates to protective covers and particularly to an outdoor cover for protecting plants and other objects during adverse weather conditions.

2. Discussion of the Prior Art

The use of covers to protect outdoor plants is well known, and there are many types of plant covers available in the art. Many of these covers are not desirable for placing in a lawn or garden due to their unattractive appearance. Thus, there is a desire and a need in the art to provide a protective plant cover that is simple in construction, easy to use, cost effective, while at the same time is aesthetically pleasing. There is also a desire and need in the art for a protective cover that provides options such as weighted components to assist in holding the protective cover in position, and lights to further enhance the aesthetics of the plant cover.

### SUMMARY OF THE INVENTION

Accordingly, the present invention provides a protective cover configured to cover an outdoor plant or other object to protect it from adverse weather conditions while at the same time providing aesthetically pleasing landscape ornamentation.

In one embodiment of the present invention, an outdoor protective cover includes an upper cover having an outer surface and a top defining an interior space, and an open bottom portion. A decorative display including at least one light is attached to the upper cover.

In another embodiment of the present invention, an outdoor protective cover includes a generally cone shaped upper cover defining an interior space, a top including an aperture, and an open bottom portion. A partition is attached, such as through molding, to the upper cover within the interior space. The partition, upper cover and top define a cavity configured to hold fill material and the upper cover includes a decorative display.

In another embodiment of the present invention, an outdoor protective cover includes an upper cover having a top defining an interior space, and an open bottom portion. A base is connected to the upper cover and a motion detector is attached to the base.

In yet another embodiment of the present invention, an outdoor protective cover includes a generally cone shaped upper cover having a top defining an interior space, and an open bottom portion. A base is connected to the upper cover and a sound emitting device is positioned within said interior space.

Other features of the present invention will become more apparent to persons having ordinary skill in the art to which the present invention pertains from the following description and claims taken in conjunction with the accompanying figures.

### BRIEF DESCRIPTION OF THE FIGURES

The foregoing features, as well as other features, will become apparent with reference to the description and figures below, in which like numerals represent like elements, and in which:

FIG. 1 is a front perspective view of an embodiment of a cover of the present invention having molded decorative features and fiber optics;

FIG. 2 is a front perspective view of an embodiment of a cover of the present invention having painted decorative features and a reflective component;

FIG. 3 is a front perspective view of an embodiment of the present invention having attachable decorative features;

FIG. 4 is a front perspective view of an embodiment of the present invention including a light;

FIG. 5 is a sectional view taken along line 5-5 in FIG. 4;

FIG. 6 is a front perspective view of an alternate embodiment of the present invention.

### DETAILED DESCRIPTION OF THE INVENTION

The present invention generally relates to an outdoor protective cover for covering a plant or other object to protect it from adverse weather conditions that is also aesthetically pleasing or entertaining.

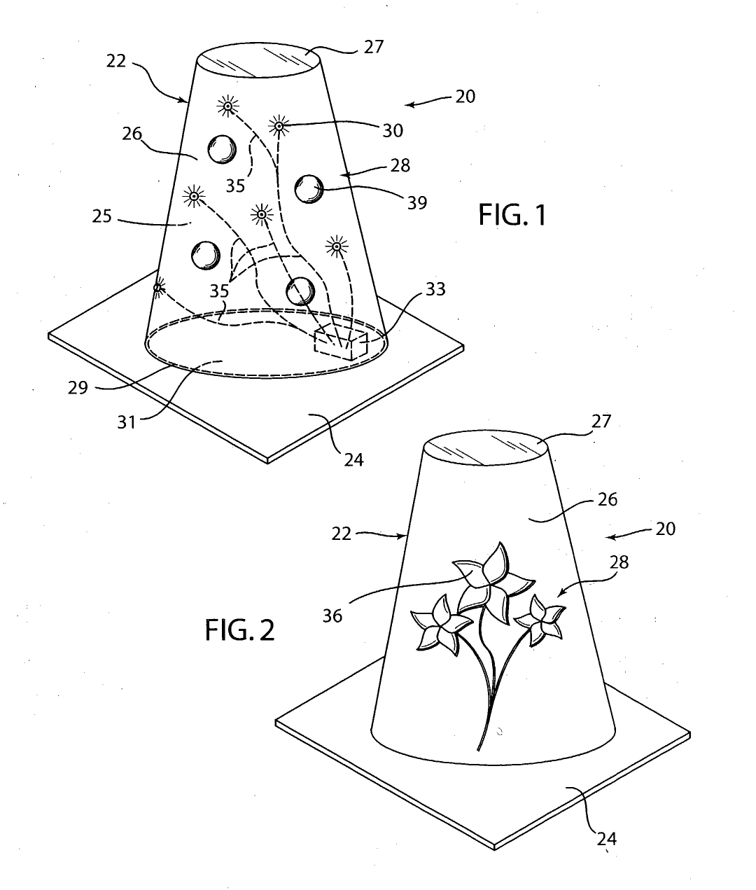

Referring to FIG. 1, an outdoor cover 20 includes an upper cover 22 and a base 24. The upper cover 22 may be formed with STYROFOAM, plastic or any other suitable material and may be generally cone shaped having a hollow interior space 25 on an underside, a closed top 27 and an open bottom portion 29. For example, the cover 20 may be used to protectively cover a desired plant or other outdoor structure vulnerable to extreme weather. The interior space 25 may provide space to allow for cover 20 to fit over an object to be protected. The upper cover 22 may be adhesively connected to base 24, or alternatively, may be formed integrally with base 24. Upper cover 22 further includes an outer surface 26 and any of a variety of decorative displays 28. The base 24 includes an opening 31 that corresponds with and is substantially the same size as bottom portion 29.

The decorative display 28 may include various combinations of features such as objects 39 molded integrally with upper cover 22, such as decorative ornaments, and fiber optics as shown in FIG. 1. By way of example only, as shown in FIG. 1, a light source 33 may be connected to upper cover 22 within interior space 25 or may be placed on the ground or surface for which cover 20 is located. Fiber optic strands 35 may be connected to light source 33 and may be configured to be placed or extend through holes 30 on outer surface 26. Strands 35 may be directly connected to light source 33 or may branch from one another. Strands 35 may be bundled or adhesively attached within an interior surface of the cover 20. Light source 33 may be battery powered, a combination of solar and battery power (not shown), or A/C adaptable. Strands 35 may be affixed to cover 20 within holes 30 by means such as adhesive, or may be sized such that there is a friction fit between strands 35 and holes 30. Other suitable attachment methods may also be used such as clipping strands 35 to holes 30.

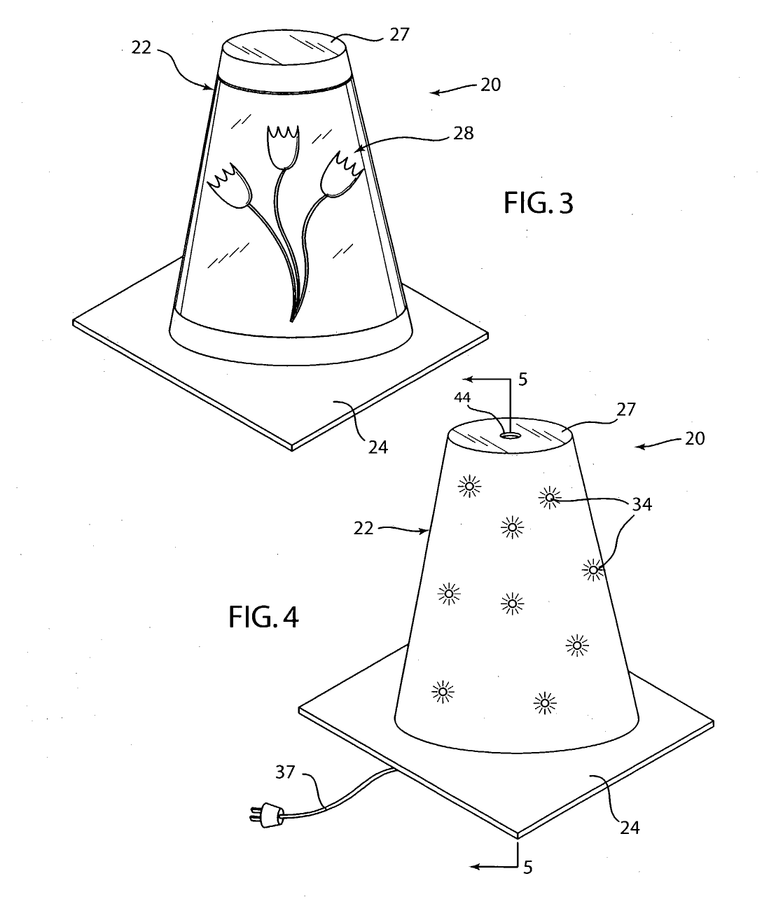

In alternate embodiments, decorative display 28 may be painted or printed on outer surface 26 as shown in FIG. 2, or may include a preprinted decorative graphical design attached to outer surface 26 by means such as adhesives, as shown in FIG. 3.

In yet another embodiment, decorative display 28 may include features having attachable decal components 36 as shown in FIG. 2. Decal components 36 may be adhesively attached to outer surface 26 or may be attached by other suitable attachment means such as clips on the back of decal components 36 that are pushed through holes 30 on upper cover 22 (not shown in FIG. 2). Decal components 36 may also be constructed of a reflective material to enable viewing in dim lighting.

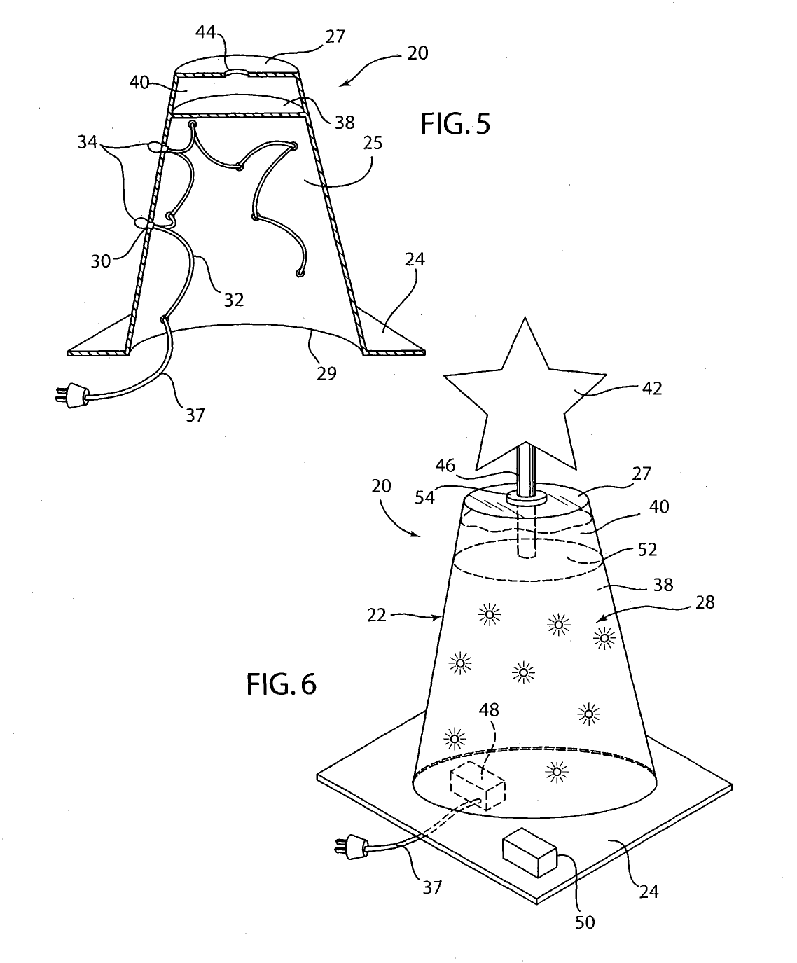

Decorative display 28 may also incorporate one or more lights such as shown in FIGS. 4 and 5. A light strand 32 may be connected to upper cover 22 within interior space 25. Light strand 32 may be A/C powered having a power cord 37 as shown in FIGS. 4 and 5, or battery powered (not shown). Lights 34 may be connected to light strand 32 and positioned within holes 30 on upper cover 22 to enhance the visual effect of the decorative display on outer surface 26. Holes 30 may be configured such that lights 34 may be frictionally held in position within holes 30, or alternatively may be connected with adhesive, clips or any other suitable attachment means. Lights 34 may include various shapes, sizes and colors and arranged in many different aesthetic patterns. FIGS. 4 and 5 also illustrate an embodiment of the present invention including an aperture 44 on top 27. Aperture 44 provides access to interior 25 and enables objects to be attached to upper cover 22, such as a decorative insert 42 as shown in FIG. 6.

In the embodiments shown in FIGS. 4, 5 and 6, cover 20 includes a partition 38 that may be molded integrally in an upper interior portion of upper cover 22 defining an upper cavity 40. Alternatively, partition 38 may be attached to upper cover 22 by other means known in the art. In this embodiment, top 27 may include aperture 44. Sand or other fill material 52 may optionally be poured into cavity 40 through aperture 44 to provide weight to protective cover 20. Decorative insert 42 may also be included having a post 46 configured to fit within aperture 44 and may include a shoulder 54 configured to rest on top 27 to help support decorative insert 42 on top 27. Decorative insert 42 may optionally be constructed of a weighted material, such as steel or other metals, to help hold down protective cover 20 in addition to, or as an alternative to the fill material 52.

Other add-on features may be incorporated into the present invention such as mounting a motion detector 50 on base 24 as shown in FIG. 6. A sound emitting device 48 may also be included and mounted or positioned within interior space 25. Both motion detector 50 and sound emitting device 48 may be battery powered or include electrical cord 37 to adapt to A/C power.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

1. An outdoor protective cover, comprising:
an upper cover having an outer surface and a top defining an interior space, and an open bottom portion; and
a decorative display including at least one light attached to said upper cover.

2. An outdoor protective cover as defined in claim 1, wherein said at least one light is attached with a friction fit connection.

3. An outdoor protective cover as defined in claim 1, wherein said decorative display further includes at least one object molded integrally with said upper cover.

4. An outdoor protective cover as defined in claim 1, wherein said decorative display further includes a preprinted graphic attached to said upper cover.

5. An outdoor protective cover as defined in claim 1, wherein said decorative display further includes a reflective component attached to said upper cover.

6. An outdoor protective cover as defined in claim 1, wherein said at least one light includes fiber optics.

7. An outdoor protective cover as defined in claim 1, wherein said at least one light is connected to a power source positioned within said open bottom portion.

8. An outdoor protective cover as defined in claim 1, further including a base having an opening and connected to said upper cover.

9. An outdoor protective, comprising:
a generally cone shaped upper cover defining an interior space, a top and an open bottom portion, said top including an aperture;
a partition attached to said upper cover within said interior space; and
wherein said partition, upper cover and top define a cavity configured to hold fill material and said upper cover includes a decorative display.

10. An outdoor protective cover as defined in claim 9, wherein said partition is molded into said upper cover.

11. An outdoor protective cover as defined in claim 9, further including a decorative insert having a post configured to fit in said aperture.

12. An outdoor protective cover as defined in claim 11, wherein said decorative insert includes weighted material to assist in holding the protective cover in position.

13. An outdoor protective cover as defined in claim 9, wherein said decorative display includes at least one light attached to said upper cover.

14. An outdoor protective cover as defined in claim 9, wherein said decorative display includes fiber optics.

15. An outdoor protective cover as defined in claim 9, wherein said decorative display includes graphical designs.

16. An outdoor protective cover as defined in claim 9, further including a base having an opening and connected to said upper cover.

17. An outdoor protective cover, comprising:
an upper cover including a top defining an interior space, and an open bottom portion;
a base connected to said upper cover including an opening; and
a motion detector attached to said base.

18. An outdoor protective cover as defined in claim 17, wherein said upper cover further includes a decorative display.

19. An outdoor protective cover, comprising:
a generally cone shaped upper cover including a top defining an interior space, and an open bottom portion;
a base connected to said upper cover; and
a sound emitting device positioned within said interior space.

20. An outdoor protective cover as defined in claim 19, wherein said upper cover further includes a decorative display.
